(19) United States
(12) Patent Application Publication
(10) Pub. No.: US 2026/0328163 A1
(43) Pub. Date: Oct. 22, 2026

(54) DUCT ARRANGEMENT

(71) Applicant: GKN AEROSPACE SWEDEN AB, Trollhättan (SE)

(72) Inventors: Dennis Rikemanson, Trollhättan (SE); Rickard Samuelsson, Trollhättan (SE)

(21) Appl. No.: 19/113,886

(22) PCT Filed: Aug. 23, 2023
(86) PCT No.: PCT/EP2023/073129

§ 371 Date: Mar. 20, 2025

(30) Foreign Application Priority Data
Sep. 23, 2022 (GB) 2213919.0

(51) Int. Cl. F02K 3/075

(52) U.S. Cl. CPC F02K 3/075; F05D 2260/213; F05D 2260/606; F05D 2260/96; F05D 2270/3061

(57) ABSTRACT

A gas turbine engine has a core flow path and an outer flow path, the outer flow path positioned at a greater radial displacement from a rotational axis of the engine than the core flow path. The gas turbine engine also has a cavity to provide fluid communication between a bleed passage and a duct, the bleed passage for communicating air from the core flow path to the cavity and the duct for communicating air from the cavity to the outer flow path. The cavity has a downstream wall. The duct has a circumferentially extending opening that provides a passage through the downstream wall adjacent to a radially outer wall of the cavity.

### BACKGROUND

The present invention is concerned with a duct arrangement and in particular, but not exclusively, a duct arrangement for communicating air from a cavity of a gas turbine engine to an outer flow path.

In order to prevent the stall of a compressor of a gas turbine engine in different engine operating conditions, a bleed passage may be provided, typically within the intermediate compressor structure. The bleed passage is arranged to release air out of the primary or core flow path so as to divert air away from the compressors under certain operating conditions and to prevent a compressor stall. This allows gas turbine engines to continue operating at a wide range of operating conditions.

The air released through the bleed passage is communicated into a cavity (which may be referred to as a chamber, a bleed plenum, or a fire zone compartment). The cavity collects air before it is released into a further flow path, such as a bypass duct which surrounds the engine core.

It can be difficult when designing an engine involving such a bleed path to route the bleed air through the engine structure from the core flow path to the further flow path into which the air is to be bled. Such difficulty may arise due to the need for the cavity, and in particular, a downstream wall of the cavity to house multiple components of the engine. Examples of such components include gear boxes, thrust links, actuators, engine monitoring and control equipment, air and fluid pipes, cables, and harnesses. Consequently, integration of all of these components can prove difficult. Even where there is space for all of these components, due to constricted nature of this area, the manufacturing of the ducts can also prove difficult.

Additionally, introducing the bleed air to the bypass duct, or more generally, the outer flow path, can disrupt the air flow through that outer flow path particularly if bleed air is introduced at an angle deviating significantly from the air flow direction in the outer flow path.

A further issue that may arise in connection with bleed passages is that particles and/or water in the bleed air extracted from the core flow path may collect and build up in the cavity.

### SUMMARY OF THE INVENTION

Aspects of the invention are set out in the accompanying claims.

Viewed from a first aspect, there is provided a gas turbine engine comprising: a core flow path and an outer flow path, the outer flow path being positioned at a greater radial displacement from the rotational axis of the engine than the core flow path; and a cavity to provide fluid communication between a bleed passage and a duct, the bleed passage for communicating air from the core flow path to the cavity and the duct for communicating air from the cavity to the outer flow path, the cavity having a downstream wall; wherein the duct comprises a circumferentially extending opening that provides a passage through the downstream wall adjacent to a radially outer wall of the cavity.

As described herein, a duct is provided to communicate the bleed air extracted (or drawn) into the cavity from the core flow path into the outer flow path via the bleed passage. The duct is in the form of a generally circumferentially extending opening and is arranged so as to define an airflow path through the downstream wall adjacent to a radially outer wall of the cavity, i.e., the duct passes through the downstream wall at a point of greatest radial displacement from a rotational axis of the gas turbine engine. For example, the duct may be formed against the radially inner wall of the outer flow path so as to extend immediately adjacent to the outer flow path in an airflow direction (i.e., downstream in the engine). In some examples, the inner wall of the outer flow path may even form part of the outer wall of the duct so that the duct is enclosed by the outer wall.

By arranging the opening so as to provide a passage through an opening in the downstream wall adjacent to a radially outer wall of the cavity, the duct can be placed away from the most congested area of the downstream wall where it is desirable to place other components (such as thrust links, actuators, engine monitoring and control equipment, air and fluid pipes, cables, harnesses and/or gearboxes), thereby enabling simpler and better optimised placement of such components. Moreover, with the duct positioned in the cavity with a relatively large radial displacement from the axis of the engine, the circumferential width of the duct can be larger than if the duct were positioned more centrally. This means that a smaller radial height of the duct can be used while still providing a desired cross-sectional area of the duct, providing a slimmer duct through the downstream wall whilst still supporting a desired capacity for bleed air flow. In this sense, the duct may have a high aspect ratio, for example with a circumferential width greater than its height in a radial direction or a circumferential width 2.5 or more times greater than its radial height (i.e., an aspect ratio of 2.5:1). In some examples, the duct may have an aspect ratio of 3:1, or 4:1, or 5:1.

A slim duct of this form further reduces the footprint of the duct on the most congested areas of the downstream wall closer to the axis of the engine.

Further, by positioning the duct as described, manufacture of the engine may be made easier since more room is provided for welding and/or bolting components together, thereby avoiding the need for large single piece casting or single prints using additive-manufacturing which can increase the production complexity.

The bleed air can contain water and/or particles that can build-up in the cavity. If the duct were positioned away from the radially outer wall of the cavity, these undesirable elements could accumulate at the bottom dead-centre of the engine under gravity. The downstream wall would then act to trap these particles and water. However, with the duct positioned adjacent the radially outer wall as discussed herein, at the bottom dead-centre of the engine the duct is thus positioned at the lowest point of the cavity and so any accumulating particles and water can be drained through the duct into the outer flow path and out of the engine.

Additionally, the duct arrangement discussed herein may allow the duct to be shortened, as compared with a duct positioned closer to the axis of the engine, such that the duct extends less far along the engine in a downstream direction. Consequently, more space may be freed up in the engine in this downstream direction as well as on the downstream wall itself.

In the bleed passage, the duct, or otherwise on the fluid communication path between the core flow path and the outer flow path, there may be provided one or more bleed valves able to be opened and closed to selectively provide or restrict the bleed flow path. In this sense, the cavity may selectively provide fluid communication from the bleed passage to the duct. That is, when the bleed valve is shut, the cavity may prevent fluid communication between the bleed passage while the cavity may be configured to enable such fluid communication when the bleed valve is open.

The outer flow path may in some examples be a bypass channel carrying bypass air or may be an intermediate flow path or low pressure core flow path arranged outside of, and carrying air at a lower pressure than, the (high pressure) core flow path. In some examples, the gas turbine engine is provided with a plurality of ducts with a subset of those ducts directing air to a first outer flow path (e.g., a bypass channel) and a different subset of those ducts directing air to a second outer flow path (e.g., an intermediate flow path). For example, the majority of air extracted from the core flow path may be directed to an intermediate flow path/bypass channel arranged beyond the core flow path while a portion of the bleed air is directed via a separate duct to an outermost air flow (e.g., outside the engine nacelle).

As used herein, the term adjacent refers to the passage provided through the downstream wall by the duct being proximate to the outer wall of the cavity, for example as illustrated in the figures. The passage may be arranged for example within the outer 25% of the downstream wall, the outer 15% of the downstream wall, or the outer 10% of the downstream wall as measured in a radial direction from a rotational axis of the engine. Functionally, the arrangement of the passage through the downstream wall provided by the duct adjacent to outer wall of the cavity enables a high aspect ratio to be used for the duct/passage (as described in more detail below), allows the duct to be positioned away from the most congested areas of the downstream wall, and provides an airflow path from the core flow path to the cavity and then through the duct to the outer flow path.

The opening could be arranged adjacent to the radially outer wall of the cavity in a number of ways. In some examples, this is achieved by providing an inlet of the duct in the downstream wall at a position adjacent to the radially outer wall of the cavity. Such an arrangement may be relatively easy to implement as an opening can be machined in the downstream wall to provide the inlet and the rest of the duct mounted in place against the downstream wall.

This inlet may in some examples be positioned immediately against the outer wall of the cavity such that it is formed at the edge of the downstream wall. In this case, the outer wall of the cavity will define an edge of the inlet thereby preventing the build-up of water and/or particles at the bottom dead-centre of the engine since the inlet extends all the way to the lowest point of the cavity.

Alternatively, the duct may extend beyond the downstream wall into the cavity with the inlet to the duct positioned inside the cavity. In this case, the duct extends through the opening in the downstream wall at a point adjacent to the radially outer wall of the cavity so as to provide a flow passage through the downstream wall at the outer edge of the downstream wall. With the inlet of the duct positioned inside the cavity, the inlet may be oriented to substantially align with an outlet of the bleed passage that introduces the bleed air to the cavity. For example, the duct inlet and the bleed passage may be oriented parallel to one another and/or positioned opposite each other in the cavity so as to direct the bleed air from the bleed passage into the inlet. In some examples, the duct may extend so far as to connect with the bleed passage to provide a direct path from the core flow path through the cavity and into the outer flow path. However, in some cases a separation may be preferred between the bleed passage and the duct to provide more space in the cavity for the mounting of other components.

Regardless of whether the duct connects directly to the bleed passage or not, by aligning the duct entry to target the exit flow from the bleed passage, the duct entry flow can be improved, improving the efficiency with which the bleed air can be guided to the outer flow path, reducing the amount of particulate matter and water deposited in the cavity, and/or improving the acoustic conditions within the cavity.

In some examples, the duct (and/or the bleed passage) is arranged to redirect the flow of air that is received. For example, the bleed passage may redirect air that is received from the core flow path from a first flow direction (that the air has in the core flow path; e.g., corresponding to flow A in FIG. 4) to a second flow direction (flow C) as it is expelled into the cavity. The duct may then redirect the air from that second flow direction to a third flow direction (flow D′). This redirection may alter the flow angle of the air by an angle of between 15° and 90° and may return the air flow to a direction parallel to the first flow direction. In some example, the duct guides the air through the downstream wall in the third flow direction and further redirects the air flow to a fourth flow direction (flow E) in order to introduce the air to the outer flow path. In this sense, the flow path formed by the duct and/or the bleed passage may have a generally serpentine shape or S-shaped arrangement.

On the other side of the downstream wall of the cavity (i.e., the side opposite the cavity), the duct may extend substantially parallel to the outer flow path remaining adjacent to the inner wall of the outer flow path. In some examples, the duct may be formed against the outer flow path (or a panel wall enclosing outer flow path) such that the inner wall of the outer flow path (or the panel wall) at least partially encloses the duct (e.g., forms one side of the duct). In this case, the other walls of the duct may be sealed to the inner wall of the outer flow path so as to contain the bleed flow in the duct.

In some examples, the duct has a separate wall enclosing the duct which may be mounted so that the duct runs adjacent to the outer flow path.

The inner wall of the outer flow path may then have an outlet formed in it to introduce the bleed air to the outer flow path. In order to reduce the disturbance caused to the outer flow, the duct may be arranged to introduce the bleed air in a substantially axial flow direction (i.e., aligned with the flow in the outer flow path). In this way, the duct can substantially align the bleed flow introduced to the outer flow path with the flow already in the outer flow path and thereby reduce the disruptive effect of introducing this air flow. Where the duct extends axially adjacent to the outer wall before reaching the outlet to the core flow path, this can further help to align the bleed flow with the air flow direction of the outer flow path. If instead the duct were arranged to pass through the downstream wall at a point away from the radially outer wall of the cavity, the duct would need to redirect the bleed flow in a radially outwards direction to reach the outer flow path and so the bleed flow would be introduced at a greater angle to the outer flow causing additional disruption to the outer flow.

In some examples the cavity is generally annular in extent with circumferentially spaced struts or strut extensions provided through the cavity for support. A plurality of ducts may be provided between the struts/strut extensions with each duct providing a passage through the downstream wall adjacent to the radially outer wall of the cavity. Where a plurality of ducts are provided, the duct may cover a significant portion of the angular extent of the engine, and for example may be arranged over 60% or more of the angular extent of the downstream wall.

The positioning of the duct may be selected to avoid interfering with components positioned in the outer flow path. For example the outer flow path may contain guide vanes to direct the air through the outer flow path. Additionally, or alternatively, the outer flow path may contain one or more heat exchangers to make use of the cooler air in the outer flow path. Introducing the bleed air to the outer flow path may interfere with the directed air flow from the guide vanes and/or the operation of the heat exchangers since the bleed air from the core flow will typically be hotter than the air in the outer flow path (e.g., the bypass channel). As such, the duct may be arranged to introduce the bleed air into the outer flow path at a position downstream of the guide vanes and/or the heat exchangers.

To further reduce the production complexity of the duct structure, the duct may be formed separately from the rest of the cavity and then mounted within the gas turbine engine. For example, an opening could be machined in the downstream wall, the duct inserted into the cavity and placed against or inserted through the opening and then mounted in place (e.g., by welding or bolt joints).

In some examples, a surface of the duct and/or the bleed passage has an acoustic liner or is otherwise provided with a surface designed to reduce the noise produced by the engine.

Since the bleed system may be used selectively based on engine operating conditions, an openable and closable bleed valve may be provided to control the flow of air from the core flow path into the outer flow path. This bleed valve may be situated in the bleed passage or in the duct, for example covering the inlet to the bleed passage, the outlet of the bleed passage, the inlet of the duct and/or the outlet of the duct.

Viewed from a second aspect, there is provided an intermediate compressor structure for a gas turbine engine, the intermediate compressor structure comprising: a core flow path; and a cavity to provide fluid communication between a bleed passage and a duct, the bleed passage for communicating air from the core flow path to the cavity and the duct for communicating air from the cavity, the cavity having a downstream wall; wherein the duct comprises a circumferentially extending opening that provides a passage through the downstream wall adjacent to a radially outer wall of the cavity.

Viewed from a third aspect, there is provided a method of manufacturing a gas turbine engine, the method comprising: providing a core flow path and an outer flow path, the outer flow path positioned at a greater radial displacement from the rotational axis of the engine than the core flow path; providing a cavity between the core flow path and the outer flow path, the cavity having a downstream wall; forming a bleed passage between the core flow path and the cavity; and forming a duct between the cavity and the outer flow path; wherein forming the duct comprises forming a circumferentially extending opening that provides a passage through the downstream wall adjacent to a radially outer wall of the cavity.

Viewed from a fourth aspect, there is provided a method of manufacturing a gas turbine engine, the method comprising: providing a core flow path and an outer flow path, the outer flow path positioned at a greater radial displacement from the rotational axis of the engine than the core flow path; providing a cavity between the core flow path and the outer flow path, the cavity having a downstream wall; forming a bleed passage between the core flow path and the cavity; inserting a duct extending between the cavity and the outer flow path; and mounting the duct within the gas turbine engine; wherein the duct comprises a circumferentially extending opening and is mounted to provide a passage through the downstream wall adjacent to a radially outer wall of the cavity.

Viewed from a fifth aspect, there is provided a method of operating the gas turbine engine as described herein, the method comprising: causing air to selectively flow from the core flow path into the cavity via the bleed passage and to flow from the cavity to the outer flow path via the duct.

Optional features of the first aspect are also optional features of the second, third, fourth, and fifth aspects.

### FIGURES

Further aspects, features, and advantages of the present invention will be apparent from the following description of examples, which is to be read in conjunction with the accompanying drawings, in which:

FIG. 1 shows a cross-section of a gas turbine incorporating a duct according to an example implementation;

FIGS. 2A-2C show the arrangement of the duct in more detail;

FIG. 3 shows another cross-section of the gas turbine engine taken along a different axis;

FIG. 4 shows an arrangement of the duct according to an alternative example implementation;

FIG. 5 is a flow chart illustrating a method of manufacture of the gas turbine engine; and

FIG. 6 is a flow chart illustrating another method of manufacture of the gas turbine engine in which the duct is manufactured separately and installed within the engine.

Any reference to prior art documents in this specification is not to be considered an admission that such prior art is widely known or forms part of the common general knowledge in the field. As used in this specification, the words “comprises”, “comprising”, and similar words, are not to be interpreted in an exclusive or exhaustive sense. In other words, they are intended to mean “including, but not limited to”. The invention is further described with reference to the following examples. It will be appreciated that the invention as claimed is not intended to be limited in any way by these examples. It will also be recognised that the invention covers not only individual embodiments but also combination of the embodiments described herein.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the spirit and scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

In the present application, the words “configured to ...” are used to mean that an element of an apparatus has a configuration able to carry out the defined operation. In this context, a “configuration” means an arrangement or manner of interconnection of hardware or software. “Configured to” does not imply that the apparatus element needs to be changed in any way in order to provide the defined operation.

### DETAILED DESCRIPTION

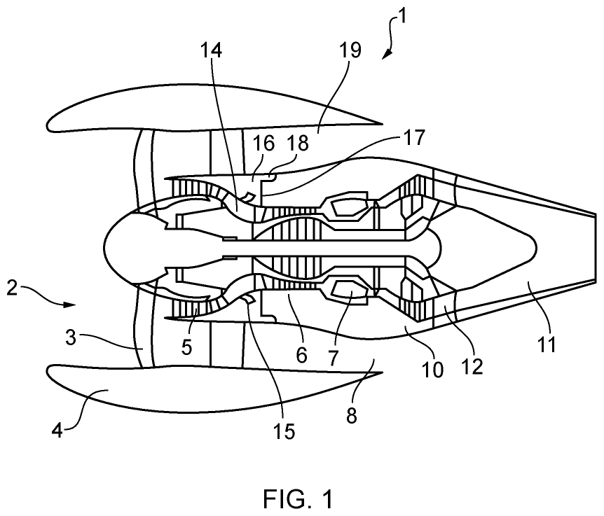

FIG. 1 shows a cross-section of a gas turbine engine 1 incorporating a duct according to the invention, as described in detail below.

The skilled person will understand the principal components of a gas turbine engine and their operation. In summary, the engine 1 comprises an air intake 2 which permits air to flow into the engine to the fan 3 located at the upstream end of the engine. All of the components are housed within the engine nacelle 4.

The engine comprises a bypass channel 19 downstream of the fan and a central engine core which contains the compressors, combustors and turbines. The core of the engine is formed of a first low pressure compressor 5 and a second high pressure compressor 6. This multi-stage compressor arrangement takes air from ambient pressure and temperature to high temperature and pressure. Compressed air is then communicated to the combustion chamber 7 where fuel is injected and combustion occurs. It will be appreciated that this arrangement is only one example of how the engine could be arranged. In other examples, the engine may have a geared fan or open fan, for example.

The combustion gases are expelled from the rear of the combustion chamber 7 and impinge first on a high pressure turbine 10 and then on a second low pressure turbine 12 before leaving the rear of the engine through the core nozzle 11. Thrust from the engine is created by two gas flows: a first from the fan nozzle 8 (receiving thrust from the fan) and secondly from the exhaust gases from the core nozzle 11.

It will be appreciated that the gas flow in the engine 1 progress from left to right across FIG. 1. Accordingly, a rightwards direction in FIG. 1 can be referred as a downstream direction of the engine 1 with a leftwards direction in FIG. 1 corresponding to an upstream direction of the engine.

A transition duct 14 is arranged to receive air from the low pressure compressor 5 and communicate it radially inwards to be supplied to the high pressure compressor 6.

As shown, both compressors are coaxial with the central (rotational) axis of the turbine. The low pressure compressor 5 has a larger outer radius (measured from the central axis of the compressor) than the outer radius of the high pressure compressor 6.

This requires that the duct or channel communicating air between the two compressors is a generally S shaped to communicate the compressed air towards the central axis of the turbine and into the high pressure turbine 6.

It is desirable to be able to release or bleed some air within the transition duct out of the engine. This may be used to control the volume of air being passed to the high pressure compressor and prevent a compressor stall, for example.

As shown in FIG. 1, a bleed duct 15 is provided which provides an openable passage allowing air to selectively flow from the transition duct 14 into a cavity 16 (which may in some implantations be referred to as a plenum or fire zone compartment). The cavity 16 may be arranged downstream of the low pressure compressor 5. Specifically the cavity 16 may be arranged radially outside of the core and the bleed passage is usually located downstream of the low pressure compressor 5 and receives air that is released from the main flow path. In effect the cavity 16 acts as a collecting chamber or reservoir for air released from the main flow path.

The cavity is enclosed on a downstream side by a firewall 17 (which may also be referred to as a downstream wall). The firewall 17 provides a boundary between fire zones of the engine 1 to prevent the leakage of flammable fluids between different sections of the engine 1. To allow the bleed air to escape from the cavity 16 into the bypass channel 19, a duct 18 is provided through the firewall 17. The duct 18 may provide a passage through the firewall 17 at a radially extreme point of the firewall 17 such that the duct 18 may be considered to provide the passage above or beyond the firewall.

As shown in FIG. 1, the bleed duct 15, the cavity 16 and the duct 18 provide a flow path to communicate bleed air between the core flow path and the bypass channel 19. In other implementations, the bleed air may instead or additionally be communicated from the core flow path to another flow path within the gas turbine engine 1 such as intermediate flow path of a low pressure core flow path situated radially further from the axis of the engine 1 than the core flow path.

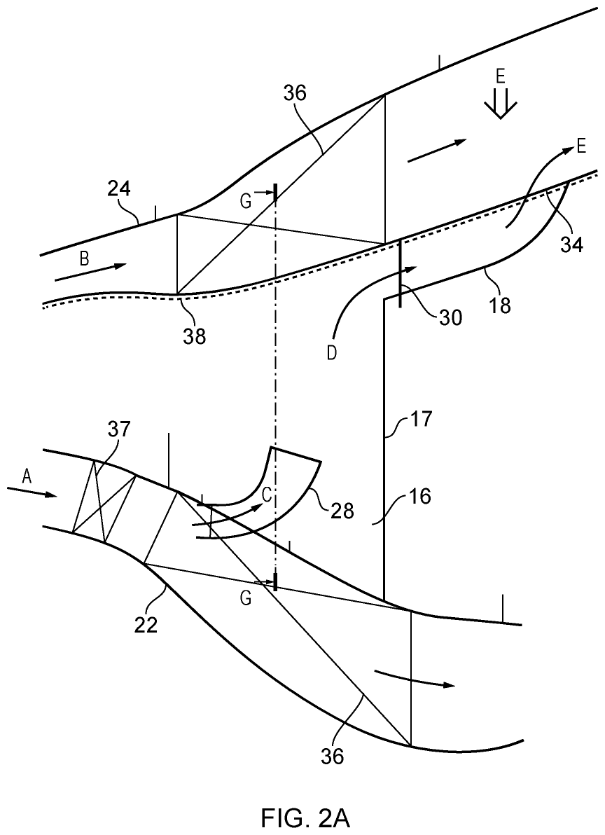

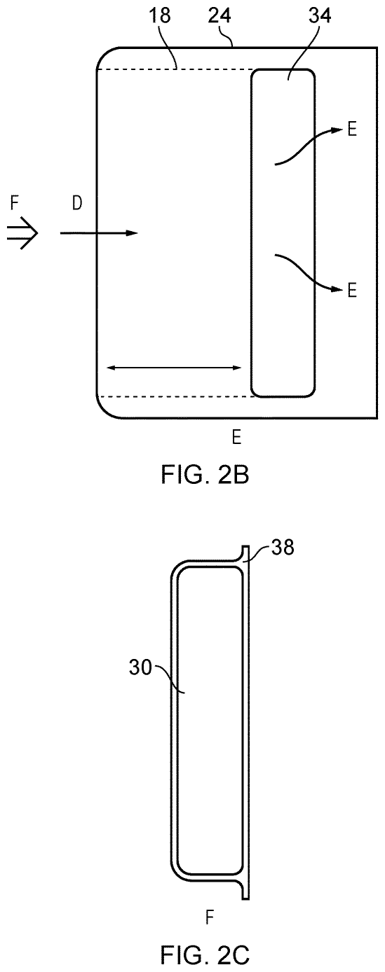

The arrangement of the duct 18 will be described in more detail in relation to the other figures. FIG. 2A shows a cross-section view of the cavity 16 and its position in relation to the core flow path 22 and the outer flow path 24 (which may for example be the bypass channel 19 illustrated in FIG. 1). As shown in FIG. 2, there is provided a core flow path 22 carrying core flow A. The axis of the engine 1 is situated below the bottom of FIG. 2A and so the outer flow path 24 carrying the outer flow B is situated further from the axis of the engine 1 than the core flow path 22.

To allow bleed air flow C to escape the core flow path 22, there is a bleed passage 28 extending from the core flow path 22 into the cavity 16. The bleed passage 28 is openable and closable using a bleed valve or bleed door that can be controlled to allow, prevent, and/or control the amount of bleed air leaving the core flow path 22.

The cavity 16 into which the bleed air is provided sits between the core flow path 22 and the outer flow path 24 in a radial direction. A downstream end of the cavity 16 is enclosed by a firewall 17. The firewall 17 is provided to separate fire zones within the engine that operate at different temperatures. Here, the firewall sits between the low pressure compressor 5 and the high pressure compressor 6, although it will be appreciated that the same techniques may be applied more generally between compressor stages where the engine has more than two compressors.

Providing a passage through the firewall 17 is a duct 18. The duct 18 is positioned such that it passes through an opening in the firewall 17. This duct 18 is able to direct the bleed air introduced in bleed air flow C from the cavity 16 into the outer flow path 24. The core flow path 22 operates at a higher pressure than the outer flow path 24 and so, in use, the air introduced to the cavity 16 will naturally flow from the cavity 16 out through the duct 18 into the outer flow path 24 as flow D.

While according to one approach, a duct could be positioned in the firewall 17 away from the outer edge of the cavity 16, for example near to the core flow path 22 or halfway between the core flow path 22 and the outer flow path 24, according to the arrangement described herein, the duct 18 is arranged so that the duct 18 passes through the firewall 17 at a position adjacent to the outer wall of the cavity 16, i.e., the wall formed by the inner surface of the outer flow path 24.

As shown in FIG. 2A, the duct 18 is positioned against the outer flow path and separated by a wall 38 such that the wall 38 of the outer flow path 24 encloses one side of the duct 18 and the duct runs along next to the outer flow path 24. However, it will be appreciated that in other implementations, the duct 18 may not be positioned immediately adjacent to the radially outer wall of the cavity 16 but more generally may be positioned at a radially extreme end of the firewall 17. In such cases, the duct 18 may be positioned so as to enable a high aspect ratio between the circumferential width and the radial height to be employed. For example, an aspect ratio of 2.5:1, 3:1, 4:1, or 5:1 may be used.

The positioning of the duct such that it provides a passage through the firewall 17 adjacent to the radially outer wall of the cavity reduces the space occupied by the duct 18 at the most congested area in the firewall 17 and simplifies the routing of the duct to the outer flow path 24. Further, the height of the duct 18 in a radial direction can be reduced when placed adjacent to the radially outer wall of the cavity 16 since the circumferential extent of the duct 18 can be increased in order to provide the required air flow. The positioning of components in the firewall 17 can be particularly challenging since various components may need to be integrated with each other at this point. As such, by positioning the duct 18 in this way, the integration of components on the firewall 17 can be simplified.

In the example implementation shown in FIG. 2A, an inlet 30 of the duct 18 is provided in the firewall 17 and an outlet 34 of the duct 18 to release the air into the outer flow path 24 is provided in the inner wall of the outer flow path 24. The inlet 30 may be provided as part of the firewall 17 or may be positioned beyond an outer edge of the firewall 17.

The duct 18 runs substantially parallel to the outer flow path 24 before reaching the outlet 34. By positioning the duct at the outer edge of the cavity 16 and running the duct 18 alongside the outer flow path 24 in this way, when the air is introduced to the outer flow path 24, the air flow E is oriented substantially parallel to the outer air flow B which reduces the disruption to the outer air flow as the bleed air is introduced.

The outer flow path 24 carries cooler air than the core flow path 22 and so use may be made of this cooler air for cooling components of the engine. For example, where the gas turbine engine 1 makes use of a reduction gearbox, large amounts of heat may be dissipated even where the efficiency of the gearbox is high. In order to cool the gearbox, cold air in the bypass channel of the engine 1 may be used to remove and control the heat. This allows the gearbox to be conveniently cooled. To do this, a heat exchanger (not shown) may be positioned in the outer flow path 24 (which may be the bypass channel) to dissipate heat into the outer flow path 24 (e.g., heat from a reduction gearbox).

Where such a heat exchanger is provided, the outlet 34 of the duct 18 is positioned downstream of the heat exchanger to prevent hotter bleed air from the core flow path 22 from interacting with the heat exchangers and potentially reducing the efficiency of the heat dissipation from the heat exchanger.

Similarly, where the outer flow path 24 contains guide vanes to manipulate the air flow, the outlet 34 may be positioned to introduce the bleed air into the outer flow path 24 downstream of the guide vanes to avoid interfering with the operation of the guide vanes.

In some examples, the surface of the bleed duct 15 and/or the duct 18 is provided with acoustic liners and/or surfaces configured to reduce engine noise.

Also depicted in FIG. 2A are struts 36 provided in the core flow path 22 and the outer flow path. Strut extensions may be used to create a load path between the inner struts and the outer struts. Guide vanes 37 are also provided in the core flow path 22 to remove swirl in the core air flow before the flow enters the core flow path. In this example therefore, the bleed passage 28 is positioned between struts in the core flow path 22 and their strut extensions. In some examples, other components such as heat exchangers and/or stators may be provided in the outer flow path 24.

FIG. 2B shows another view of the duct 18, viewed along the direction E indicated in FIG. 2A from the outer flow path 24. As shown in FIG. 2B, the outer flow path 24 extends from left to right in a downstream direction with the duct 18 shown in dotted lines extending below the outer flow path 24 and directing air flow D along the duct 18 and out of the outlet 34 to introduce the bleed air to the outer flow path 24 as air flow E. That is, a bleed door may be opened or closed to prevent air flowing through the outlet 34. In some examples, the bleed door or bleed valve may alternatively or additionally be positioned in the bleed duct 28.

As illustrated in FIG. 2B, the duct 18 has a bleed valve that can be opened or closed to allow or prevent bleed air from flowing into the outer flow path 24.

FIG. 2C shows another view of the duct 18 viewed along the direction F shown in FIG. 2B. Accordingly, FIG. 2C illustrates a view looking along the length of the duct 18 in an air flow direction. As shown in FIG. 2C, there is an inlet 30. This inlet 30 is arranged in the firewall 17 of the cavity 16 with its location being adjacent to the outer wall of the cavity to form a passage/opening in the firewall 17 adjacent to the outer wall of the cavity.

To seperate the duct 18 and the outer flow path 24 is a wall 38, as shown in FIG. 2C.

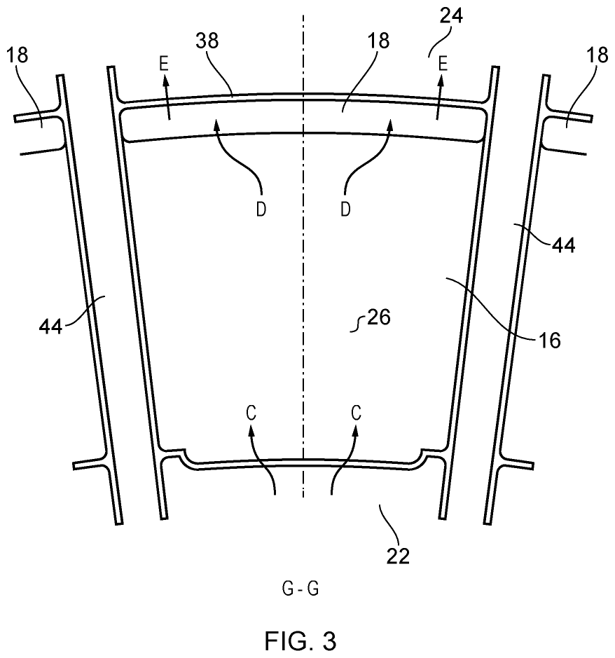

FIG. 3 shows another cross-section of the gas turbine engine taken along the line G-G shown represented in FIG. 2A. FIG. 3 illustrates the core flow path 22 and the outer flow path 24 separated by the cavity 16 with the firewall 17 at its downstream end. At angular intervals around the gas turbine engine 1 are positioned struts 44 to support the structure of the engine 1.

Several bleed passages and ducts 18 are arranged between these struts/strut extensions 44 and the ducts 18 together may extend circumferentially over more than 60% of an annulus around the engine 1. It can be seen in FIG. 3 that the opening of the duct in the firewall 17 extends circumferentially around the firewall 17 forming a lozenge-shape. Despite occupying a large circumferential width, the ducts 18 can be arranged with a high aspect ratio such that they cover only a small radial height. In some examples, an aspect ratio of circumferential width to radial height of greater than 2.5 is used. By positioning the ducts 18 adjacent to the outer wall of the cavity 16 (i.e., adjacent to the wall 38 enclosing the outer flow path 24), this reduced radial height can be achieved whilst still providing a sufficient cross-sectional area to direct the bleed air. Additionally, by placing the ducts 18 in this way, a greater flow area can be achieved if required as it is easier to accommodate a larger area of duct 18 in this location than would be possible if the ducts 18 were located elsewhere in the firewall 17.

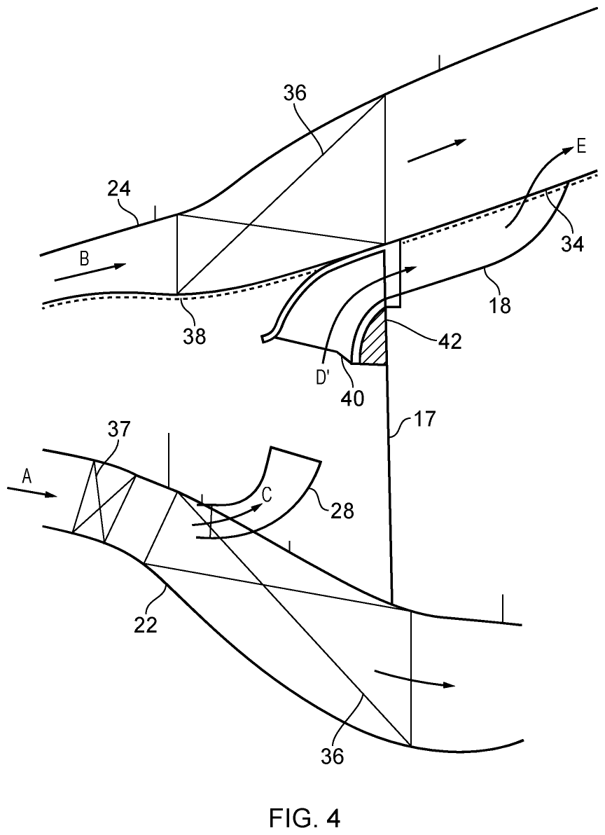

FIG. 4 shows a cross-section of the cavity 16 of engine 1 according to another example implementation. Elements of FIG. 4 corresponding to similar elements of FIG. 2A will not be discussed detail again with respect to FIG. 4.

According to the example implementation shown in FIG. 4, there is again provided a duct 18; however, the duct 18 now extends into the cavity 16 such that the inlet 40 protrudes from the firewall 17. The duct 18 is still arranged so as to provide a passage through the firewall 17 (or part of the firewall 17) adjacent to the wall 38 enclosing the outer flow path 24 with the duct 18 extending through an opening formed at the edge of the firewall 17.

The inlet 40 is aligned using a mount 42 so as to receive bleed air flow C from the bleed passage 28 as air flow D′. To this end, the inlet 40 is positioned opposite an outlet of the bleed passage 28 in the cavity 16 thereby improving the efficiency of air flow between the bleed passage 28 and the duct 18.

Directing the air flow in this way may also improve particle extraction and water ejection from the cavity 16, preventing a build-up of particles/water in the cavity 16.

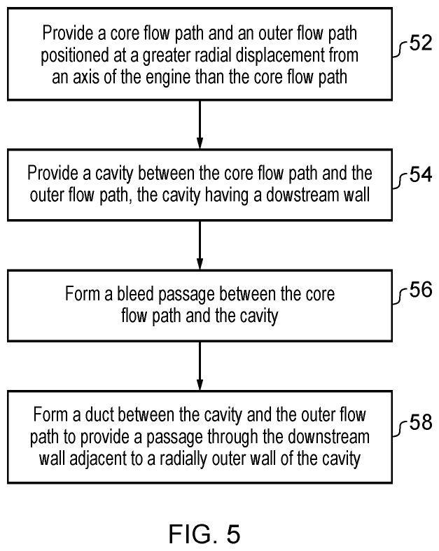

FIG. 5 is a flow chart illustrating a method of assembly of the gas turbine engine 1. At step 52, a core flow path 22 and an outer flow path 24 (which may for example be a bypass channel) are provided with the outer flow path 24 positioned at a greater radial displacement from an axis of the engine than the core flow path 24.

A cavity 16 having a downstream wall such as a firewall 17 is provided between the core flow path 22 and the outer flow path 24 a step 54 and a bleed passage 28 is formed between the core flow path 22 and the cavity 16 at step 56 and is configured to communicate bleed air from the core flow path 22 into the cavity 16.

Then a duct 18 is formed between the cavity 16 and the outer flow path 24 at step 58 to communicate air from the cavity 16 into the outer flow path 24. This duct 18 is formed so as to provide a passage through a circumferentially extending opening in the downstream wall at a location adjacent to a radially outer wall of the cavity 16.

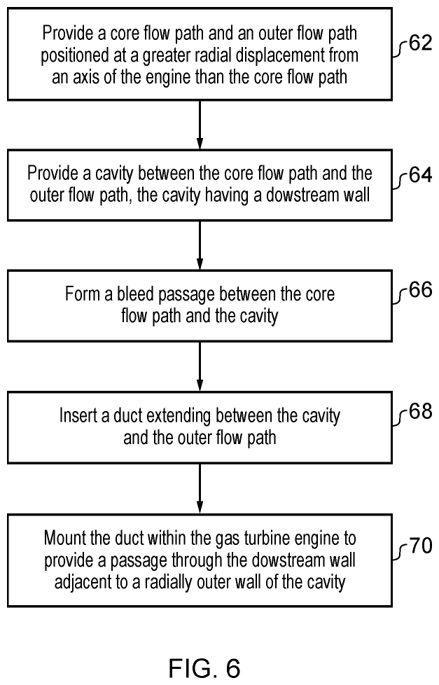

FIG. 6 is a flow chart illustrating another method of assembly of a gas turbine engine 1 as described herein in which the duct 18 is manufactured separately and installed within the engine 1. Steps 62-66 of FIG. 6 correspond to steps 52-56 of FIG. 5 and so will not be discussed in detail here.

In this method however, a duct 18 may be manufactured separately and inserted at step 68 into the gas turbine engine 1 so as to extend between the cavity 16 and the outer flow path 24. This duct 18 is then mounted at step 70 and located so as to provide a passage through a circumferentially extending opening in the downstream wall adjacent to a radially outer wall of the cavity 16. The duct 18 may for example be welded or bolted in place on the downstream wall. Due to its position on the firewall, as discussed above, more room may be available for weld lines and/or bolted joints than if the duct 18 were situated elsewhere, thereby simplifying this step of mounting the duct 18.

Thus, there has been described an arrangement of a duct for a bleed system of a gas turbine engine that is able to free up space within the engine for other equipment and functions, enable easier manufacture, and less disruptive introduction of air into the outer flow path.

1. A gas turbine engine comprising:
a core flow path and an outer flow path, the outer flow path being positioned at a greater radial displacement from the rotational axis of the engine than the core flow path; and
a cavity to provide fluid communication between a bleed passage and a duct, the bleed passage for communicating air from the core flow path to the cavity and the duct for communicating air from the cavity to the outer flow path, the cavity having a downstream wall;
wherein the duct comprises a circumferentially extending opening that provides a passage through the downstream wall adjacent to a radially outer wall of the cavity.

2. The gas turbine engine according to claim 1, wherein the circumferentially extending opening has a circumferential width greater than its height in a radial direction.

3. The gas turbine engine according to claim 1 2, wherein the circumferentially extending opening has an aspect ratio of circumferential width to radial height of greater than 3:1.

4. The gas turbine engine according to claim 1, wherein the duct extends adjacent to a radially inner wall of the outer flow path in an airflow direction such that the inner wall of the outer flow path at least partially encloses the duct, and wherein the duct intersects the inner wall of the outer flow path to provide an outlet into the outer flow path.

5. The gas turbine engine according to claim 1, wherein the inner wall of the outer flow path separates the cavity and the outer flow path, and the duct comprises an outlet formed in the inner wall of the outer flow path for providing air to the outer flow path.

6. The gas turbine engine according to claim 1, wherein the duct extends axially adjacent to the outer wall and wherein the duct is arranged to introduce the air to the outer flow path with a substantially axial flow direction.

7. The gas turbine engine according to claim 1, wherein the duct comprises an inlet for receiving air from the cavity, the inlet formed in the downstream wall adjacent to the radially outer wall of the cavity.

8. The gas turbine engine according to claim 7, wherein the inlet is positioned against the outer wall of the cavity such that the outer wall forms an edge of the inlet.

9. The gas turbine engine according to any of claim 1, wherein the duct comprises an inlet for receiving air from the cavity, the inlet formed in the cavity, wherein the duct extends into the cavity from the circumferentially extending opening.

10. The gas turbine engine according to claim 9, wherein the inlet is oriented to be substantially aligned with an outlet of the bleed passage.

11. The gas turbine engine according to claim 1, wherein:
the bleed passage is arranged to redirect air from a first flow direction to a second flow direction, wherein the air in the core flow path has the first flow direction; and
the duct is arranged to redirect the air from the second flow direction to a third flow direction substantially parallel to the first flow direction.

12. The gas turbine engine according to claim 9, wherein the duct is arranged to redirect air by an angle of between 15° and 90°.

13. The gas turbine engine according to claim 1, wherein the engine comprises a plurality of circumferentially spaced struts and/or strut extensions and a plurality of ducts for communicating air from the cavity to the outer flow path, wherein each duct provides a passage the downstream wall adjacent to the outer wall and between neighbouring struts and/or strut extensions.

14. The gas turbine engine according to claim 1, the gas turbine engine comprising a plurality of ducts, wherein each duct comprises a circumferentially extending opening that provides a respective passage through the downstream wall adjacent to the outer wall of the cavity, and wherein together the respective passages are arranged over more than 60% of the angular extent of the downstream wall.

15. The gas turbine engine according to claim 1, the gas turbine engine comprising one or more heat exchangers positioned in the outer flow path, wherein the duct is arranged to introduce air into the outer flow path downstream of the one or more heat exchangers.

16. The gas turbine engine according to claim 1, wherein the duct is formed separately from the cavity and is mounted within the gas turbine engine.

17. The gas turbine engine according to claim 1, the gas turbine engine comprising one or more guide vanes positioned in the outer flow path, wherein the duct is arranged to introduce air into the outer flow path downstream of the one or more guide vanes.

18. The gas turbine engine according to claim 1, wherein a surface of the bleed passage and/or the duct comprises an acoustic liner.

19. The gas turbine engine according to claim 1, wherein the duct comprises a bleed valve operable to control the flow of air into the outer flow path.

20. The gas turbine engine according to claim 1, wherein the outer flow path is a bypass flow path.

21. The gas turbine engine according to claim 1, wherein the outer flow path is an intermediate flow path or a low pressure core flow path.

22. The gas turbine engine according to claim 1, wherein the bleed passage is positioned at a compressor stage of the gas turbine engine.

23. An intermediate compressor structure for a gas turbine engine, the intermediate compressor structure comprising:
a core flow path; and
a cavity to provide fluid communication from a bleed passage to a duct, the bleed passage for communicating air from the core flow path to the cavity and the duct for communicating air from the cavity, the cavity having a downstream wall;
wherein the duct comprises a circumferentially extending opening that provides a passage through the downstream wall adjacent to a radially outer wall of the cavity.

24. A method comprising:
providing a core flow path and an outer flow path, the outer flow path positioned at a greater radial displacement from the rotational axis of a gas turbine engine than the core flow path;
providing a cavity between the core flow path and the outer flow path, the cavity having a downstream wall;
forming a bleed passage between the core flow path and the cavity; and
forming a duct between the cavity and the outer flow path;
wherein forming the duct comprises forming a circumferentially extending opening that provides a passage through the downstream wall adjacent to a radially outer wall of the cavity.

25. A method comprising:
providing a core flow path and an outer flow path, the outer flow path positioned at a greater radial displacement from the rotational axis of a gas turbine engine than the core flow path;
providing a cavity between the core flow path and the outer flow path, the cavity having a downstream wall;
forming a bleed passage between the core flow path and the cavity;
inserting a duct extending between the cavity and the outer flow path; and
mounting the duct within the gas turbine engine;
wherein the duct comprises a circumferentially extending opening and is mounted to provide a passage through the downstream wall adjacent to a radially outer wall of the cavity.

26. The method according to claim 24, further comprising:
causing air to selectively flow from the core flow path into the cavity via the bleed passage and to flow from the cavity to the outer flow path via the duct.
